(19) United States
(12) Patent Application Publication
(10) Pub. No.: US 2004/0241030 A1
(43) Pub. Date: Dec. 2, 2004

(54) Scroll fluid machine

(75) Inventor: Shinji Matsushima, Yokohama-shi (JP)

Correspondence Address: ZARLEY LAW FIRM P.L.C., CAPITAL SQUARE, 400 LOCUST, SUITE 200, DES MOINES, IA, 50309-2350, US

(73) Assignee: Anest Iwata Corporation, Kanagawa (JP)

(21) Appl. No.: 10/850,639

(22) Filed: May 21, 2004

(30) Foreign Application Priority Data
May 23, 2003 (JP) 2003-146608

(51) Int. Cl. F03C 2/00; F04C 18/00

(52) U.S. Cl. 418/60; 418/83

(57) ABSTRACT

A scroll fluid machine has a fixed scroll in a housing and an orbiting scroll rotatably mounted to a driving shaft. A fixed wrap of the fixed scroll is engaged with an orbiting wrap of the orbiting scroll. The orbiting scroll is revolved at a certain eccentricity by the driving shaft, so that a gas sucked through the circumference of the housing is compressed as it moves toward the center, and discharged through the center. A gas-guiding bore is formed near the center of the orbiting scroll, and a heat-releasing rod is inserted in the bore. One end of the heat-releasing rod is projected from the fixed scroll to release heat to atmosphere.

### BACKGROUND OF THE INVENTION

The present invention relates to a scroll fluid machine, and particularly to a scroll fluid machine, such as a scroll vacuum pump or a scroll pressurizing machine, in which a fixed wrap of a fixed scroll in a housing is engaged with an orbiting wrap of an orbiting scroll rotatably connected to an eccentric axial portion of a driving shaft, the orbiting scroll being revolved at a certain eccentricity by the driving shaft, thereby compressing a gas sucked from the circumference or the center of the housing as it moves toward the center or circumference and being discharged.

Such a scroll fluid machine is known among persons skilled in the art.

A scroll fluid machine runs for a long time, so that temperatures of a driving shaft, an eccentric axial portion of the driving shaft, bearings and packings rise to result in damage in the bearings and packings or in leak of lubricating oil. Hence it makes the machine impossible to use.

To increase durability of the scroll fluid machine, it is necessary to avoid excessive high temperature on the eccentric axial portion of the driving shaft during long-time operation.

To comply with such requirements, the following measures are taken and known among persons skilled in the art.

(1) Low or room temperature air or nitrogen is introduced into a compressing portion of a scroll fluid machine to dilute toxicity in the compressing portion.

(2) A gas-guiding bore is axially formed in a driving shaft, and a low or room temperature air or nitrogen is discharged through the gas-guiding bore. After it passes through the bearing, it is introduced into the compressing portion, which is cooled by the air or nitrogen which is discharged.

(3) An eccentric axial portion of the driving shaft is formed as hollow into which low or room temperature air is introduced to cool the eccentric axial portion.

However there are disadvantages as below in the foregoing measures.

In order to introduce low or room temperature air or nitrogen into the compressing portion, it is necessary to provide introducing paths and outside supply means. Thus, the structure becomes complicate and makes its size larger to result in high cost.

A gas-guiding bore is axially formed in a driving shaft, and low or room temperature air or nitrogen is discharged through the gas-guiding bore by centrifugal force caused by rotation of the driving shaft to cool bearings. In this device, when the driving shaft stops, a toxic or foreign-substance-containing gas in a compressing portion runs back and is discharged to atmosphere through the gas-guiding bore, thereby causing contamination in atmosphere.

### SUMMARY OF THE INVENTION

In view of the foregoing disadvantages, it is an object of the present invention to provide a scroll fluid machine in which air is introduced through the circumference of a housing during operation to cool an eccentric axial portion of a driving shaft, bearing therefor and other members automatically to increase durability.

### BRIEF DESCRIPTION OF THE DRAWINGS

The above and other features and advantages of the invention will become more apparent from the following description with respect to embodiments as shown in appended drawings wherein:

FIG. 1 is a vertical sectional side view of an embodiment of a scroll fluid machine according to the present invention; and

FIG. 2 is a vertical sectional side view of another embodiment of a scroll fluid machine according to the present invention.

### DETAILED DESCRIPTION OF PREFERRED EMBODIMENTS

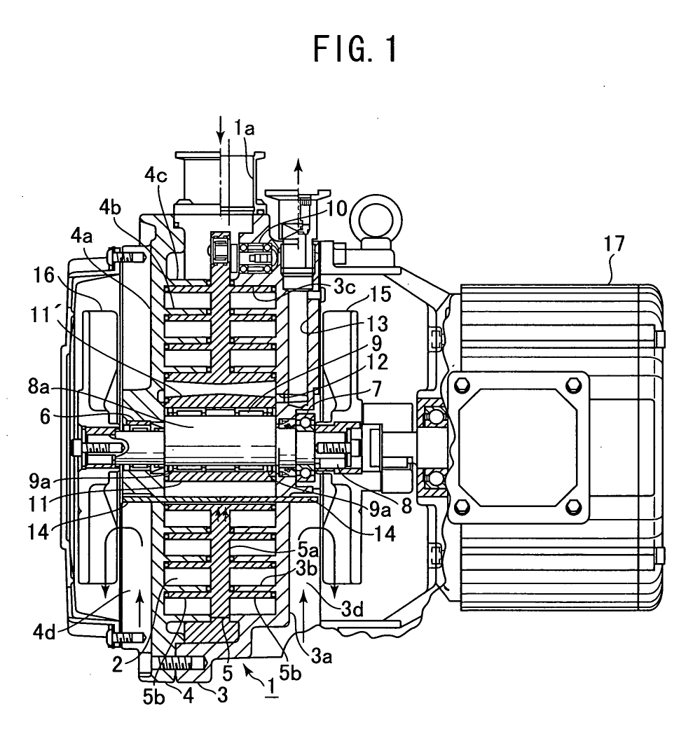

FIG. 1 is a vertical sectional side view of one embodiment of a scroll fluid machine or a scroll vacuum pump according to the present invention, in which an orbiting scroll is revolved at a certain eccentricity, so that a gas through the circumference of a housing is sucked into a compressing portion between the orbiting scroll and a fixed scroll, compressed as it moves toward the center and discharged through the center.

The numeral 1 denotes a housing having a closed disc-like compression chamber 2, and comprises a casing 3 and a cover 4, a sucking bore 1a being formed on the circumference.

The housing 3 and cover 4 have fixed end plates 3a and 4a which surround the compression chamber 2 and oppose each other. Fixed wraps 3b and 4b are provided towards the compression chamber 2 to form the fixed scrolls 3c and 4c.

A plurality of cooling radial fins 3d and 4d are provided on the outer sides of the fixed end plates 4a and 4a. Between the fixed end plates 3a and 4a in the compression chamber 2, the orbiting scroll 5 is provided to revolve around an axis of the compression chamber 2.

The orbiting scroll 5 has an orbiting end plate 5a each surface of which has orbiting wraps 5b,5b engaged with the fixed scrolls 3c,4c, deviating by 180 degrees, and is rotatably supported on an eccentric axial portion 8a of a driving shaft 8 via a needle bearing 9 and a packing 9a. The driving shaft 8 is provided with bearings 6,7 in the center of the housing 1.

The orbiting end plate 5a is engaged with the fixed end plate 3a via three known pin-crank rotation preventing mechanisms 10 spaced uniformly on the circumference. As the driving shaft 8 rotates, the orbiting end plate 5a eccentrically revolves in the compression chamber 2 to change radial space between the fixed wraps 3b,4b and orbiting wraps 5b,5b engaged with each other.

A plurality of axial gas-guiding bores 11,11 are formed near the center of the orbiting end plate 5a. The gas-guiding bore 11 above the eccentric axial portion 8a functions as compressed gas path and communicates at one end with a discharge bore 13 formed inwardly from the circumference of the fixed end plate 3a via an axial communicating bore 12 near the center of the fixed end plate 3a.

Two heat pipes 14,14 disposed in series are inserted as a heat-releasing rod into the gas-guiding bore 1 under the eccentric axial portion 8a in FIG. 1, and the outer end of each of the heat pipes 14 passes through the fixed end plates 3a and 4a and extends over approximately whole axial length of the cooling fins 3d,4d near the inner end of the cooling fins 3d,4d.

Thus, projecting portions of the heat pipes 14 from the fixed end plates 3a and 4a communicate with atmosphere via a plurality of fins 3d,4d.

The driving shaft 8 has cooling fans 15,16 at the ends which extend from the fixed end plates 3a,4a. The cooling fans 15,15 sucks air towards the center via the fins 3d,4d and discharge it away from the center.

When the driving shaft 8 is rotated by a motor 17, the orbiting scroll 5 rotatably mounted to the driving shaft 8 is revolved at a certain eccentricity while it is engaged with the fixed scroll 3c,4c, and air sucked through the sucking bore 1a is compressed as it comes towards the center, thereby raising temperature. Thus, the inner ends of the heat pipes 14,14 in the gas-guiding bore 11 near the center of the orbiting scroll 5 are heated.

However, the outer ends of the heat pipes 14,14 are projected from the fixed scrolls 3c,4c and cooled with the cooling fans 15,16 by air which flows via the cooling fins 3d,4d and circulates. So heat in the inner end of the heat pipe 14 or the orbiting scroll 5 is effectively released, thereby preventing excessive rise in temperature at the center of the orbiting scroll 5. Furthermore, the needle bearing 9 and packing 9a are not damaged with heat or enclosed grease is prevented from flowing out.

Instead of the heat pipe 14, heat-releasing rod, tube or plate made of high heat-conductive material such as Cu is made as heat-releasing rod and inserted into the gas-guiding bore 11. The outer ends are projected from the fixed end plates 3a and 4a and cooled with atmosphere. The projecting portions of the rod-like releasing material from the fixed end plates 3a,4a are made as flat as possible or as thin as possible, or a number of notches or wave-shape is formed to increase heat releasing effect.

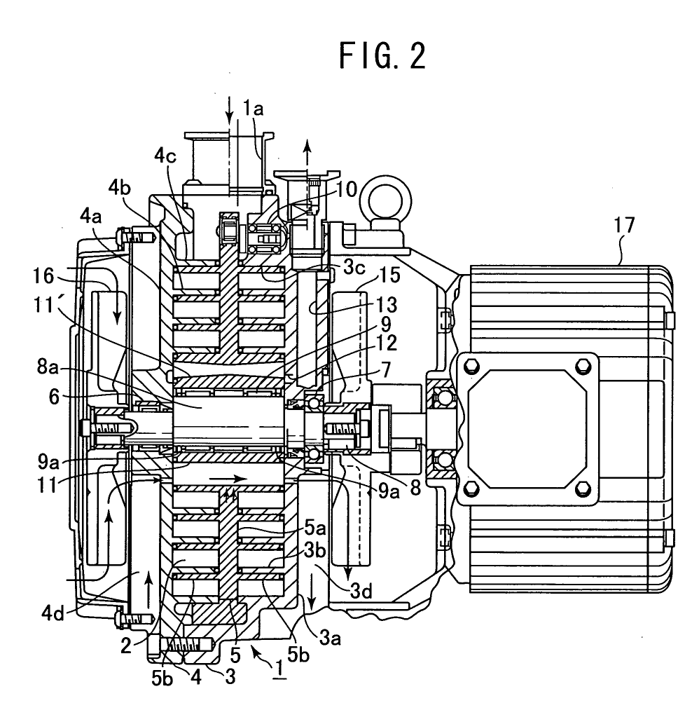

FIG. 2 illustrates another embodiment of a scroll fluid machine, in which the same numerals are allotted to the same members as those in FIG. 1 and description therefor is omitted.

In FIG. 2, with nothing in a gas-guiding bore 11, cooling fans 15,16 with opposite pitches are rotated by a motor 17 to generate gas flow in a certain axial direction. Air is sucked from one end of the gas-guiding bore 11 by cooling fans 15,15 and discharged through the other end of the gas-guiding bore 11 after the gas-guiding bore 11 is effectively cooled. In addition to such device in which gas flow is generated in one axial direction, a heat pipe 14 or heat-releasing material as above is provided in the gas-guiding bore 11 thereby achieving more advantageous effect.

The foregoing embodiments relate to a both-side scroll fluid machine in which both-side orbiting scrolls are provided between two fixed scrolls, but the present invention is also applied to a one-side scroll fluid machine in which a one-side orbiting scroll is engaged with a one-side fixed scroll.

The foregoing merely relates to embodiments of the invention. Various changes and modifications may be made by a person skilled in the art without departing from the scope of claims wherein.

What is claimed is:

1. A scroll fluid machine comprising:
a housing;
a driving shaft having an eccentric axial portion;
a fixed scroll having a fixed wrap in the housing;
an orbiting scroll rotatably mounted to the eccentric axial portion of the driving shaft, having an orbiting wrap, said orbiting scroll being revolved at a certain eccentricity by the driving shaft so that a gas sucked through a circumference of the housing is compressed as it moves toward a center of the orbiting scroll and discharged;
a gas-guiding bore formed axially near the center of the orbiting scroll; and
a heat-releasing rod inserted in the gas-guiding bore, one end of the heat-releasing rod being projected from the fixed scroll to release heat to atmosphere.

2. A scroll fluid machine as claimed in claim 1 wherein the heat-releasing rod comprises a heat pipe.

3. A scroll fluid machine comprising:
a housing;
a driving shaft having an eccentric axial portion;
a fixed scroll having a fixed wrap in the housing;
an orbiting scroll rotatably mounted to the eccentric axial portion of the driving shaft, having an orbiting wrap, said orbiting scroll being revolved at a certain eccentricity by the driving shaft so that a gas sucked through a circumference of the housing being compressed as it moves toward a center of the orbiting scroll and discharged; and
a gas-guiding bore formed axially near a center of the orbiting scroll, air being passed through the gas-guiding bore thereby releasing heat generated near the center of the orbiting scroll.

4. A scroll fluid machine as claimed in claim 3, further comprising a cooling fan rotated by the driving shaft near an opening end of the gas-guiding bore, air flow generated by the cooling fan passing through the gas-guiding bore.

5. A scroll fluid machine as claimed in claim 4 two cooling fans having opposite pitches are provided so that the gas flow may pass in a certain direction.
